(19) United States
(12) Patent Application Publication
(10) Pub. No.: US 2021/0107220 A1
(43) Pub. Date: Apr. 15, 2021

(54) SUPPLY CONTAINER

(71) Applicant: HEWLETT-PACKARD DEVELOPMENT COMPANY, L.P., Spring, TX (US)

(72) Inventor: Juan J Hernandez, San Diego, CA (US)

(21) Appl. No.: 16/499,252

(22) PCT Filed: Oct. 5, 2017
(86) PCT No.: PCT/US2017/055316

§ 371 Date: Sep. 28, 2019

(51) Int. Cl. B29C 64/255

(52) U.S. Cl. CPC B29C 64/255; B33Y 30/00

(57) ABSTRACT

A container is disclosed. The container includes a housing formed to receive a supply having a composition of material that is altered from an original supply. A memory device is included in the housing. The memory device includes a writable field to receive data indicative of an altered composition of the supply.

### BACKGROUND

Three-dimensional printing, also referred to as additive manufacturing, is a process used to create three-dimensional objects including articles and devices in which layers of material are formed under computer control. In one example, three-dimensionally printed objects can be of many shapes and geometry and are produced from a three-dimensional model or other data source such as an Additive Manufacturing Format (AMF) data file, StereoLithography (STL) data file, or other data format for describing the object.

### BRIEF DESCRIPTION OF THE DRAWINGS

FIG. 1 is a block diagram illustrating an example supply container.

FIG. 2 is a block diagram illustrating an example three-dimensional printing system including the example supply of FIG. 1.

FIG. 3 is a block diagram illustrating an example method of the example system of FIG. 2.

FIG. 4 is a block diagram illustrating an example feature of the example supply container of FIG. 1.

### DETAILED DESCRIPTION

Additive manufacturing includes several benefits over conventional production methods and technologies; among these benefits include customization, convenience, and efficiency. For example, simple modifications to a computer-aided design (CAD) file can produce new variations to an object in a relatively short amount of time. The variations can be produced in-house rather than having to rely on remote production facility to create and then ship each object, and additive manufacturing can be far more cost effective for producing objects than traditional manufacturing techniques. The more quickly a company can create and test prototypes, the more quickly it can settle on a final design, and up until recently, roughly three-quarters of three-dimensional printing was directed toward prototyping. With recent developments to additive manufacturing, a transition is underway in which more three-dimensionally printed objects are being mass manufactured for finished products.

In an example of three-dimensional printing, a supply of granular material can be used to form each individual layer of the desired product. Examples of the granular material can include a powdery material, pellets, filaments, or some combination. A removable supply container can be used to provide the material to a three-dimensional printing system. For example, the material may be deposited from the supply container to a hopper or vessel within the printing system. The removable supply container may include a memory device or other machine-readable indicia to indicate the parameters, or characteristics, of the supply included in the container. The printing process can receive the parameters of the supply and adjust a printing process accordingly. The printing process provides a measured quantity of material, such as from the hopper or vessel, for three-dimensional printing of a desired product. In one example, a material spreading mechanism, such as a mechanism including a roller, can distribute and compresses the material in a fabrication bin to a desired thickness. In this example, a print head can be used to deposit a printing agent, such as an energy absorbing fusing agent, a chemical binder agent, or the like, in a two dimensional pattern, A thin cross section of the desired product is generated based on where the printing agent was deposited. The print head may also eject colorants, or colored printing agents such as color fusing agents, into the layer of powder to provide a desired color or color pattern for this particular cross section of the desired product. The desired product may be subject to heat, ultraviolet radiation, or other energy during processing. The material becomes solidified in the areas where the adhesive or binder or fusing agent is deposited to form a thin layer of the desired product. The process can be repeated with a new layer of powder being applied over the top of the previous layer in the bin. A subsequent cross section of the desired product is then printed with printing agents into the new powder layer. The printing agent also serves to solidify the adjacent or successive layers of the desired product together. Alternatively, portions of adjacent or successive layers may be fused by selectively printing fusing agents and by applying thermal energy to the layer of build material. This process continues, layer-by-layer, until the entire object is formed. The extra material that is non-solidified is then brushed or vacuumed away leaving the base object for further processing. The extra material may be reclaimed, or recycled in the system as re-circulated material.

The re-circulated material may be contained in a hopper or vessel within the printing system that is separate from the hopper or vessel of original material. The re-circulated material can be combined with original material and be reused in a subsequent three-dimensional printing process. The re-circulated material, however, may include properties that have been changed from the original material, such as from the re-circulated material being subjected to heat or other processing during previous use. The system can track the amount of re-circulated material and other parameters of the re-circulated material. The system can apply a selected ratio of original material and re-circulated material for the printing process. For example, a printing process may include a selected ratio based on whether the object is a draft object or final object, based on parameters, or characteristics, of the materials, based on economic considerations, or based on other considerations.

Occasionally, a material stored in a hopper or vessel of the printing system may be returned to the supply containers. For example, excess or surplus re-circulated material may be offloaded to a supply container, such as an empty supply container. In industrial or other capacities, in which an additive manufacturing system may swap the supply of original and re-circulated materials for other materials depending on the application or desired object, and the supply of original and re-circulated material may be offloaded to a supply container. If the supply container that has received material from the printing system is removed, the system may lose track of material properties of the supply that may create issues if the supply is reinstalled into the system.

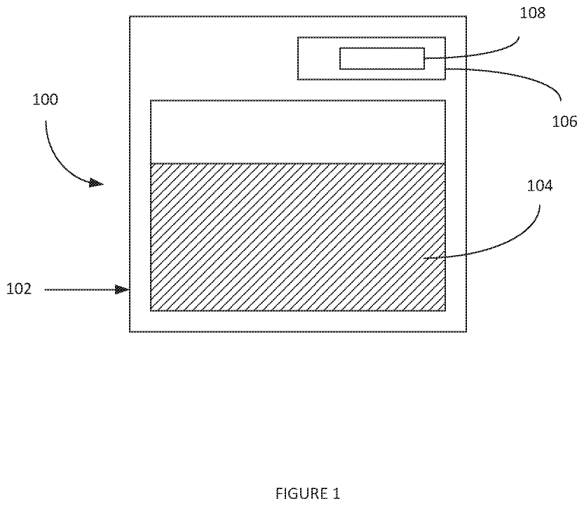

FIG. 1 illustrates an example container 100. The container includes a housing 102 formed to receive a supply 104 having a composition that is altered from an original supply. For example, the container can be an empty container to receive a material offloaded from a printing system. In one example, the container may include an original supply that is to provided to a system and can receive a subsequent supply that includes a composition altered from the original supply. The altered composition of the supply, in one example, can include a re-circulated material. The material can be used for three-dimensional printing.

A memory device 106 is included with the housing 102. The memory device 106 can be used to store data indicative of supply parameters and be machine-readable by a printing system to receive the stored supply parameters. In one example, the memory device 106 is a memory chip. The memory device 106 includes a writable field 108 to receive data indicative of an altered composition of the supply 104. In one example, the memory device 106 includes an immutable field that includes data indicative of the original supply in addition to the writable field 108. The writable field 108 can be written to and read by a three-dimensional printing system.

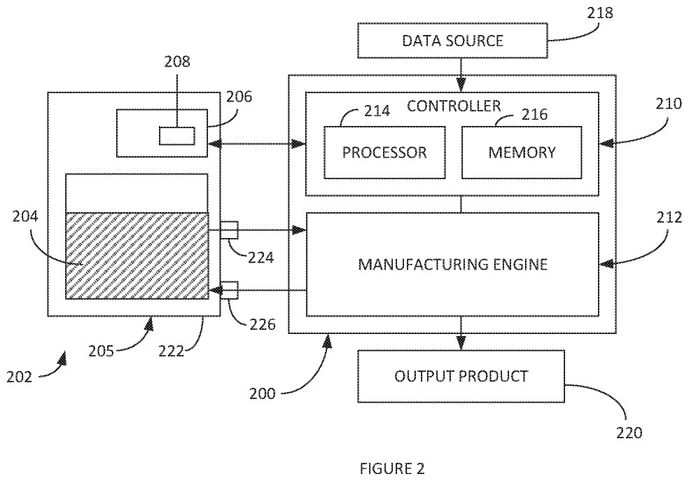

FIG. 2 illustrates an example system 200 that can be coupled to a removable supply container 202 constructed in accordance with container 100. The container 202 can receive a supply 204 within a housing 205. The supply 204 to be received into the housing 205 includes a composition altered from an original supply. The housing 205 includes a memory device 206 having a writable field 108 to receive data from the system 200 to indicate the altered composition of the supply 204. In an example, several supply containers can be coupled to the system 200.

In the example, system 200 includes a controller 210 and manufacturing engine 212. The controller 210 can include a processor 214 and memory 216. The container 202 is installed in the system 200 to provide the supply 204 to the manufacturing engine 212. A data source 218 representative of the design of a desired product is provided to the controller 210, such as a CAD file or AMF file. The controller 210 is operably coupled to the memory device 206 and can receive parameters of the supply 204. Based on the design of the desired object in the data source 218, parameters of the supply stored in the memory device 206, and other selected considerations, the controller 210 can configure the manufacturing engine 212 to produce the desired product as an output 220. In one example, the system 200 can include a vessel to include material from the container 202 as original material or original supply, and a vessel to include material reclaimed from previous applications of the manufacturing engine 212 as re-circulated material or re-circulated supply.

Examples of the system 200 can include a two-dimensional imaging system or a three-dimensional printing system, and the container 202 can include a toner cartridge in the case of an imaging system or a container of granular material in the case of a three-dimensional printing system. In the case of a three-dimensional printing system, the controller 210 can be programmed to, among other things, control the positioning and repositioning of print heads and the bin of the manufacturing engine 212 as well as other manufacturing parameters during the three-dimensional printing process of the desired product output 220. The controller 210 can take the form of a discrete module positioned proximate to the manufacturing engine 212. Alternatively, the operations performed by the controller 210 can be distributed among a plurality of controllers, processors or other circuitry. Also, the controller 210 can be remotely located relative to the manufacturing engine. In one example, the operations performed by the controller can be included in an application stored in memory 216 and executable by the processor 214.

The manufacturing engine 212 can also be in the form of an integrated module or the operations of the manufacturing engine 212 can be distributed among a plurality of modules. For example the manufacturing engine 212 can include a processing station, a build unit, and printer as modules in the manufacturing engine. One or more of the processing station, build unit, and printer modules may be integrated together in a single device, or, in one example, the processing station, build unit, and printer modules are separate devices with a repositionable build unit. In one example of the manufacturing engine 212, build materials are operably provided to the processing station. The supply container 202 is operably coupled to the processing station and can provide materials used in the manufacture of the desired object output 220 to the build unit. The build unit can include a build bin and be installed into the printer. The printer can include a print head, such as a print head including inkjet technology for ejecting a fusing agent, binder or adhesive on a powder layer to form the layers of the desired object. In inkjet technology, the print head ejects drops of print agent in a selective pattern to create the image being printed, or to color the object being fabricated. The term print agent is used broadly to mean any substance ejected by a print head to form an object being fabricated and can include binders, adhesives, fusers, detailers that can be clear or colored. After printing, the desired object in the build unit can be cooled, if appropriate, and unpacked in the processing station. Non-solidified material can be recovered from the build unit via vacuums or brushes on the processing station and included in a hopper or vessel within the system 200 as re-circulated material.

In one example, the container 202 can include a wall 222 forming the housing 205. The housing 205 can include an outlet 224 such as a port that is operably couplable to the system 200 to provide the supply 204 to the manufacturing engine 212. The housing 205 can also include an inlet 226 such as a port that is operably couplable to the system 200 to receive material from the manufacturing engine 212, such as excess re-circulated material offloaded from the system 200 into the container 202. In some examples, the outlet 224 and inlet 226 are the same port. The memory device 206 can be embedded within the wall 222. The memory device 206 can store data regarding various parameters of the supply 204 such as the type of material and amount of material, such as volume or weight, in the container 202. In another example, the memory device 206 can include data (which can include processor-executable instructions) to identify the container 202, and the processor 214 can read this data to detect the parameters of the container 202 or the supply 204. Based on the parameters of the container or the supply, the controller can adjust or select a mode of processing the data source 218 to obtain the output 220. The memory device 206 is operably coupled such as communicably coupled to the processor 214 such as via signal pathways coupled to contacts on the memory device 206 or via a wireless connection over a selected protocol.

For some parameters that can be alterable during use, such as volume or weight of the supply 204 received into the container 202, the controller 210 can store the parameter such as in memory 216 and can adjust and track by parameter in memory 216 as it is altered. In one example, the controller 210 can initially determine an amount or volume of the supply in the container 202 by reading the memory device 206 when the container 202 is installed into the system 200. As loading the supply into the system 200 reduces the supply 204 in the container 202, the amount of supply 204 remaining in the container 202 can be tracked in memory. Similarly, a new container 202, for example, can include an original supply 204. During manufacturing, unused or excess material may be returned from the manufacturing engine 212 to the container 202. Other examples of an alterable composition are contemplated. The controller 210 can track the altered composition of the supply 204 such as in memory 216. Based on altered composition, the controller can adjust or select a mode of manufacturing, or, for example, if the altered composition is not fit for manufacturing or is not compatible with a material already in use in the system, send an alert from the system 200.

In some examples, such as the parameters of a composition received into the container 202 that is altered from an original supply, the information tracked in memory 216 may differ or conflict with data on the memory device 206. The container 202 includes a writable field 208 so the controller 210 can write the data being tracked in memory 216 into the writable field 208 in a manner so that the controller 210 can later read the writable field and determine the altered composition of the supply 204. In one example, controller 210 tracks the altered composition in memory 216 until the container 202 is removed from the system 200. In this example, the system 200 initiates a removal procedure to prepare the container 202 for physical removal. As part of the removal procedure, the controller 210 writes data indicative of the altered composition of the supply into the writable field 208. For example, if the container 202 is to be removed yet still includes a supply 204 that may be used in manufacturing, such as if the container 202 is suitable for re-installation and use into the system 200, the controller 210 writes data indicative of the altered composition of the supply 204 into the writable field 208.

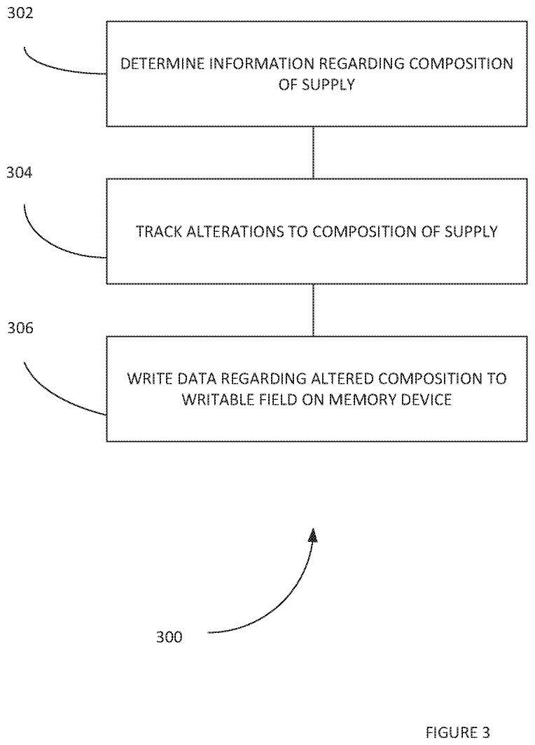

FIG. 3 illustrates an example method 300 of the system 200. Information regarding the composition of an alterable supply is determined from a memory device included in a container at 302. This information can be data or a code that can be stored in memory of the system 200. Alterations to the composition received into the container are tracked in the memory of the system as altered composition data at 304. For example, as excess re-circulated material from manufacturing engine 212 is returned to the container, such as via inlet 226, the composition is altered from an original supply. The altered composition of supply 204 can be tracked in the memory 216 at 304. Additionally, the altered amount of supply 204 within the container can be tracked in memory. Data representative of the altered composition data is written to the writable field at 306. The data representative of the altered composition data can include the data being tracked in memory or can be a representation, such as code or abbreviation, of the data being tracked in memory, that is suitable for the system 200 to read. In one example, the controller 210 writes data to the writable field 208 when the container 202 is removed from the system 200, such as part of a removal procedure when the system 200 prepares the container for removal. The controller 210 can read the data from the writable field 208 when the container 202 is reinstalled into the system 200 to obtain information regarding the composition of the supply 204.

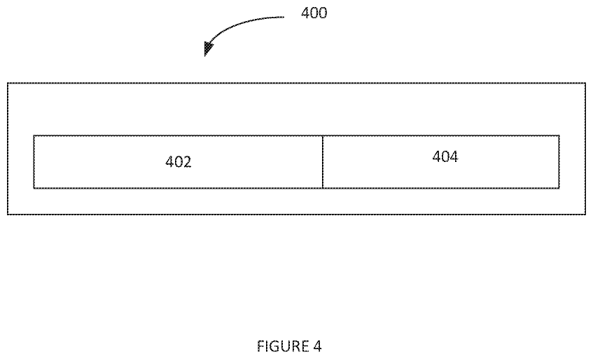

FIG. 4 illustrates an example memory device 400 that is constructed in accordance with the memory devices 106, 206. Memory device 400 can include features to store data and communicate with a controller. In one example, the memory device 400 is a memory chip, such as a cartridge chip included with a supply container, such as container 100. In the example, memory device can include a writable memory device or a combination of read only and writable memory devices. Example writable memory devices include non-volatile memory devices such as electronically programmable read only memory (EPROM), flash memory, non-volatile random access memory (NRAM) or other memory device. The memory device 400 can include additional features to resist tampering or unauthorized modification of its stored contents. The memory device 400 can include a set of fields including a read-only or immutable field 402 and a writable field 404. Read-only field 402 can include data that is not intended to be altered by a system, such as system 200, and can include information such as data to identify the container 100. Additionally, the read-only or immutable field 3402 can include data regarding the parameters of the original supply received into the container 100. Writable field or read/writable field 404 can receive data representative of information being tracked by the system, such as the altered composition of the supply such as subsequent supply offloaded from a printing system into the container. including variable amounts of original supply and re-circulated supply. In one example, the memory device 400 may be configured to allow data to be written to the writable field 404 a limited amount of times, such as once, during the lifetime of the container.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A container, comprising:
a housing formed to receive a supply having a composition altered from an original supply; and
a memory device included in the housing, the memory device having a writable field to receive data indicative of an altered composition of the supply.

2. The container of claim 1 wherein the altered composition of the supply includes a re-circulated material.

3. The container of claim 2 wherein the housing includes an inlet to receive the altered composition of the supply.

4. The container of claim 1 wherein the memory device includes another writable field to receive data indicative an amount of the supply.

5. The container of claim 1 wherein the supply includes material for three-dimensional printing.

6. The container of claim 5 wherein the field is to be written to and read by a three-dimensional printing system.

7. The container of claim 1 wherein the memory device includes a readable field indicative of supply parameters.

8. A container, comprising,
a housing formed to receive a supply;
a memory device included with the housing, the memory device having a writable field to receive data indicative of a composition of the supply including re-circulated material.

9. The container of claim 8 wherein the memory device includes another writable field indicative of an amount of the supply.

10. The container of claim 8 wherein the memory device is included within the housing.

11. The container of claim 10 wherein the housing includes a wall, and the memory device is included within the wall.

12. The memory device of claim 11 wherein the housing includes an inlet to receive the supply.

13. A container, comprising:
a housing formed to receive an original supply and a subsequent supply;
a memory device included with the housing, the memory device having an immutable field having data indicative of parameters of the original supply and a readable/writable field to receive data indicative of a composition of the subsequent supply.

14. The container of claim 13 wherein the memory device includes a memory chip.

15. The container of claim 13 wherein the composition is alterable via use of the original supply in a three-dimensional printer.
